(19) United States
(12) Patent Application Publication
(10) Pub. No.: US 2023/0135606 A1
(43) Pub. Date: May 4, 2023

(54) INFORMATION PROCESSING APPARATUS AND INFORMATION PROCESSING METHOD

(71) Applicant: Sony Group Corporation, Tokyo (JP)

(72) Inventors: Yuhei TAKI, Tokyo (JP); Hiro IWASE, Tokyo (JP); Kunihito SAWAI, Tokyo (JP); Masaki TAKASE, Tokyo (JP); Akira MIYASHITA, Tokyo (JP)

(73) Assignee: Sony Group Corporation, Tokyo (JP)

(21) Appl. No.: 17/918,129

(22) PCT Filed: Apr. 9, 2021
(86) PCT No.: PCT/JP2021/014991

§ 371 Date: Oct. 11, 2022

(30) Foreign Application Priority Data
Apr. 27, 2020 (JP) 2020-078461

(51) Int. Cl. A63F 13/215; A63F 13/53; G06F 3/16

(52) U.S. Cl. CPC A63F 13/215; A63F 13/53; G06F 3/167

(57) ABSTRACT

A terminal device (10) corresponding to an example of an information processing apparatus includes an acquisition unit (13d) that acquires a feature value related to a display element that is a target of a voice command uttered by a user, and a call determination unit (13e) (corresponding to an example of a “determination unit”) that determines a call of the display element on the basis of the feature value acquired by the acquisition unit (13d) such that the display element is uniquely specified with another display element other than the display element.

### FIELD

The present disclosure relates to an information processing apparatus and an information processing method. Background

Conventionally, an information processing apparatus that executes various types of information processing according to utterance content of a user via an interactive voice user interface (UI) is known. Such an information processing apparatus includes, for example, a game system such as an online Role-Playing Game (RPG) capable of progressing a game according to a voice command uttered by the user (See, for example, Patent Literature 1) .

### CITATION LIST

### Patent Literature

Patent Literature 1: Japanese Patent No. 6673513

### Summary

### Technical Problem

However, in the above-described conventional technology, there is still room for further improvement in assigning a uniquely identifiable call to a display element such as an object for which general-purpose voice recognition is difficult.

Specifically, for example, in the RPG or the like, a unique name is set to an object such as a monster appearing as a character, but such a name is usually not a general phrase. For this reason, a general-purpose voice recognition engine cannot perform voice recognition by converting the name of the monster into text, for example.

Note that such a problem can be solved by registering the name of a monster or the like in dictionary information used by the voice recognition engine, but it is usual that such unknown phrases such as proper nouns continue to increase. For this reason, it is not realistic to update the dictionary information in accordance with an increase in the phrase in terms of cost.

Furthermore, even when the name of a monster or the like can be recognized by voice, if the user does not know the name in the first place, the user does not know how to specify a certain monster, for example.

Therefore, the present disclosure proposes an information processing apparatus and an information processing method capable of assigning a uniquely identifiable call to a display element for which general-purpose voice recognition is difficult.

### Solution to Problem

According to the present disclosure, an information processing apparatus includes an acquisition unit that acquires a feature value related to a display element that is a target of a voice command uttered by a user, and a determination unit that determines a call of the display element on the basis of the feature value acquired by the acquisition unit such that the display element is uniquely specified with another display element other than the display element.

According to the present disclosure, an information processing method includes acquiring a feature value related to a display element that is a target of a voice command uttered by a user, and determining a call of the display element on the basis of the feature value acquired by the acquiring such that the display element is uniquely specified with another display element other than the display element.

### BRIEF DESCRIPTION OF DRAWINGS

FIG. 1 is a schematic explanatory diagram (part 1) of an information processing method according to an embodiment of the present disclosure. FIG. 2 is a schematic explanatory diagram (part 2) of the information processing method according to the embodiment of the present disclosure.

FIG. 3 is a schematic explanatory diagram (part 3) of the information processing method according to the embodiment of the present disclosure.

FIG. 4 is a diagram illustrating a configuration example of an information processing system according to an embodiment of the present disclosure.

FIG. 5 is a block diagram illustrating a configuration example of a terminal device.

FIG. 6 is a block diagram illustrating a configuration example of a server device.

FIG. 7 is a flowchart illustrating a processing procedure of first call determination processing.

FIG. 8 is a diagram (part 1) illustrating a call determination example by the first call determination processing.

FIG. 9 is a diagram (part 2) illustrating the call determination example by the first call determination processing.

FIG. 10 is a flowchart illustrating a processing procedure of second call determination processing.

FIG. 11 is a diagram (part 1) illustrating the call determination example by the second call determination processing.

FIG. 12 is a diagram (part 2) illustrating the call determination example by the second call determination processing.

FIG. 13 is a diagram (part 3) illustrating the call determination example by the second call determination processing.

FIG. 14 is a flowchart illustrating a processing procedure of third call determination processing.

FIG. 15 is a diagram illustrating a call determination example by the third call determination processing.

FIG. 16 is a flowchart illustrating a processing procedure of fourth call determination processing.

FIG. 17 is a diagram (part 1) illustrating a call determination example by the fourth call determination processing.

FIG. 18 is a diagram (part 2) illustrating the call determination example by the fourth call determination processing.

FIG. 19 is a flowchart illustrating a processing procedure of fifth call determination processing.

FIG. 20 is a processing explanatory diagram of the fifth call determination processing.

FIG. 21 is a flowchart illustrating a processing procedure of call determination processing in a case of setting a target range of call assignment.

FIG. 22 is an explanatory diagram (part 1) in a case where there is a user’s instruction to change a reference point for determining an importance level.

FIG. 23 is an explanatory diagram (part 2) in a case where there is the user’s instruction to change the reference point for determining the importance level.

FIG. 24 is a flowchart illustrating a processing procedure of an example in a case where each call determination processing is connected.

FIG. 25 is a flowchart illustrating a processing procedure of an example in a case where the call determination processing is combined.

FIG. 26 is a diagram illustrating a call example in each combination example.

FIG. 27 is a diagram (part 1) illustrating a display example in a voice UI.

FIG. 28 is a diagram (part 2) illustrating a display example in the voice UI.

FIG. 29 is a diagram illustrating a display example in a game screen.

FIG. 30 is a diagram (part 1) illustrating an application example to another use case.

FIG. 31 is a diagram (part 2) illustrating an application example to another use case.

FIG. 32 is a diagram (part 3) illustrating an application example to another use case.

FIG. 33 is a diagram (part 4) illustrating an application example to another use case.

FIG. 34 is a hardware configuration diagram illustrating an example of a computer that implements functions of a terminal device.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

In addition, in the present specification and the drawings, a plurality of components having substantially the same functional configuration may be distinguished by attaching different hyphenated numerals after the same reference numerals. For example, a plurality of configurations having substantially the same functional configuration are distinguished as a terminal device 10-1 and a terminal device 10-2 as necessary. However, in a case where it is not particularly necessary to distinguish each of a plurality of components having substantially the same functional configuration, only the same reference numeral is attached. For example, in a case where it is not necessary to particularly distinguish the terminal device 10-1 and the terminal device 10-2, they are simply referred to as the terminal device 10.

In addition, the present disclosure will be described according to the following item order.
1. Overview
2. Configuration of Information Processing System
2-1. Overall Configuration
2-2. Configuration of Terminal Device
2-3. Configuration of Server Device
2-4. Specific Example of Call Determination Processing
2-4-1. Specific Example of first call determination processing
2-4-2. Specific Example of Second Call Determination Processing
2-4-3. Specific Example of Third Call Determination Processing
2-4-4. Specific Example of Fourth Call Determination Processing
2-5. Specific Example of Common Call Determination Processing (Fifth Call Determination Processing)
2-6. Target Range of Call Assignment, or The Like
2-7. Connection or Combination of Call Determination Processing
2-8. Display Example of Call
3. Modification
3-1. Application Example to Other Use Cases
3-2. Other Modifications
4. Hardware Configuration
5. Conclusion

### 1. Overview

In the present embodiment described below, a case where an information processing system 1 according to an embodiment is a game system that provides an online RPG service capable of progressing a game via a voice UI will be described as a main example.

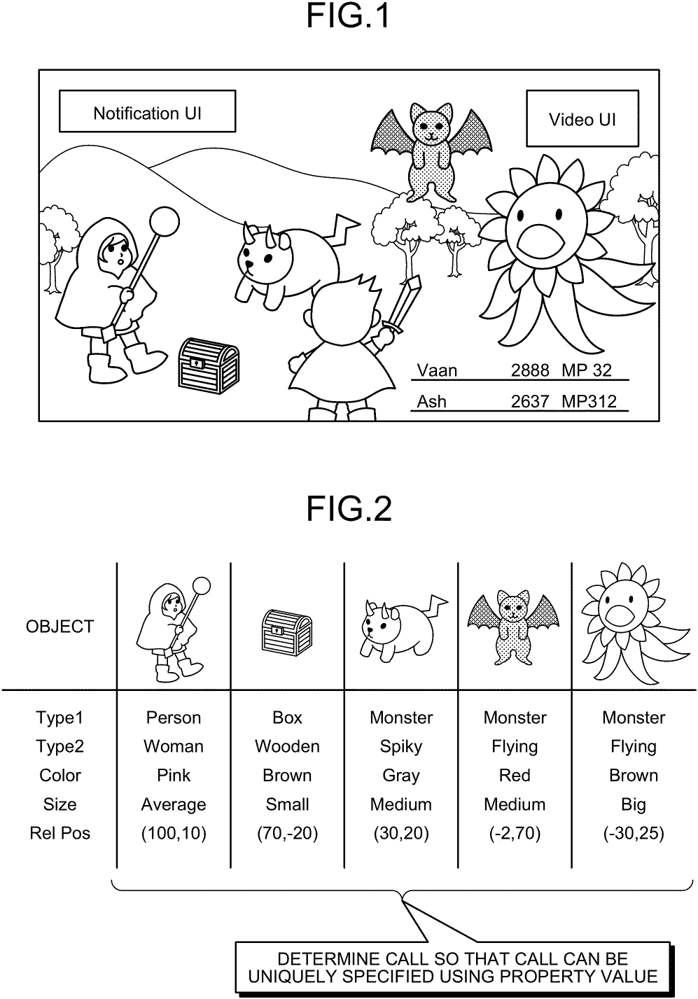

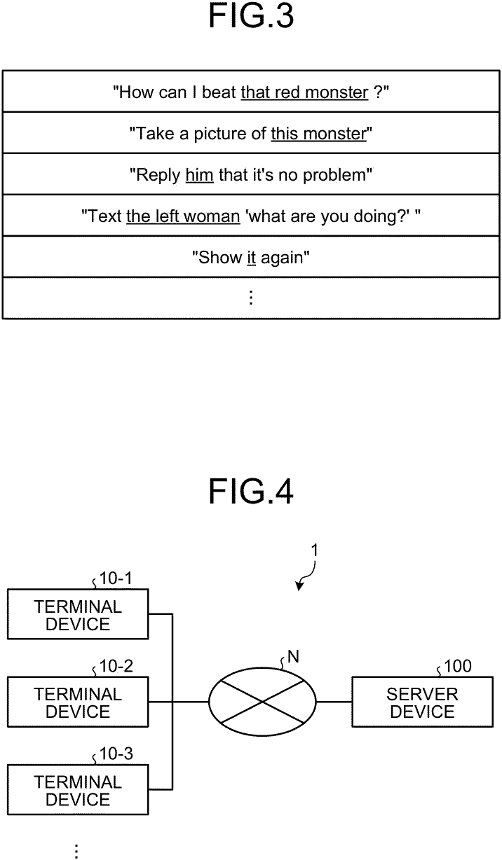

FIG. 1 is a schematic explanatory diagram (part 1) of an information processing method according to an embodiment of the present disclosure. Furthermore, FIG. 2 is a schematic explanatory diagram (part 2) of the information processing method according to the embodiment of the present disclosure. Furthermore, FIG. 3 is a schematic explanatory diagram (part 3) of the information processing method according to the embodiment of the present disclosure.

First, FIG. 1 illustrates an example of a game screen provided by the information processing system 1. As illustrated in FIG. 1, a plurality of objects such as a male character corresponding to a user himself/herself, a female character corresponding to another user, a box representing an item, and various monsters are displayed on a game screen.

Furthermore, on the game screen, for example, an operation object of an online chat function represented as “Notification UI” or the like is displayed.

The user can progress the game by uttering a voice command including the call of the object, for example, while viewing the game screen.

Note that, although various objects are usually given proper nouns in terms of game settings, these are not general phrases, and thus cannot be recognized by a general-purpose voice recognition engine. Therefore, in order to call a proper noun in the game setting as a call in the voice command, the proper noun needs to be registered in the dictionary information of the voice recognition engine.

However, even when the proper noun is registered in the dictionary information, if the user does not know the proper noun in the first place, the user does not know what utterance can be used to designate the target object.

Therefore, in the information processing method according to the embodiment of the present disclosure, a feature value regarding the object that can be the target of the voice command uttered by the user is acquired, and the call of the object is determined such that the object is uniquely specified with another object other than the object on the basis of the acquired feature value. Note that the object mentioned here corresponds to an example of a “display element” presented to the user. In addition, the feature value corresponds to a static or dynamic value indicating a feature of the display element, such as a property value or a state value to be described later.

Specifically, in the information processing method according to the embodiment, the call that can uniquely specify each object is determined using attribute information assigned as static metadata to each object and analysis information obtained as a result of image analysis of the game screen being displayed.

More specifically, as illustrated in FIG. 2, for example, each object has a property value (corresponding to an example of an “attribute value”) for each type such as “Type1”, “Type2”, “Color”... as the attribute information.

Such property values may overlap, for example, for the same type, but all property values of a plurality of objects being displayed do not coincide with each other. Therefore, in the information processing method according to the embodiment, as illustrated in FIG. 2, the call is determined so that the call can be uniquely specified using the property value.

For example, FIG. 2 exemplifies property values of three types of monsters. However, there is a property value overlap in “Type 1” and “Type 2”, but there is no property value overlap in “Color”. Therefore, these monsters can be uniquely specified by determining the calls such as “Gray Monster”, “Red Monster”, and “Brown Monster”.

By determining the call in this manner, the user can use a voice command designating an object by utterance as illustrated in FIG. 3, for example. An underlined portion is an example of the call that can be determined according to the present embodiment.

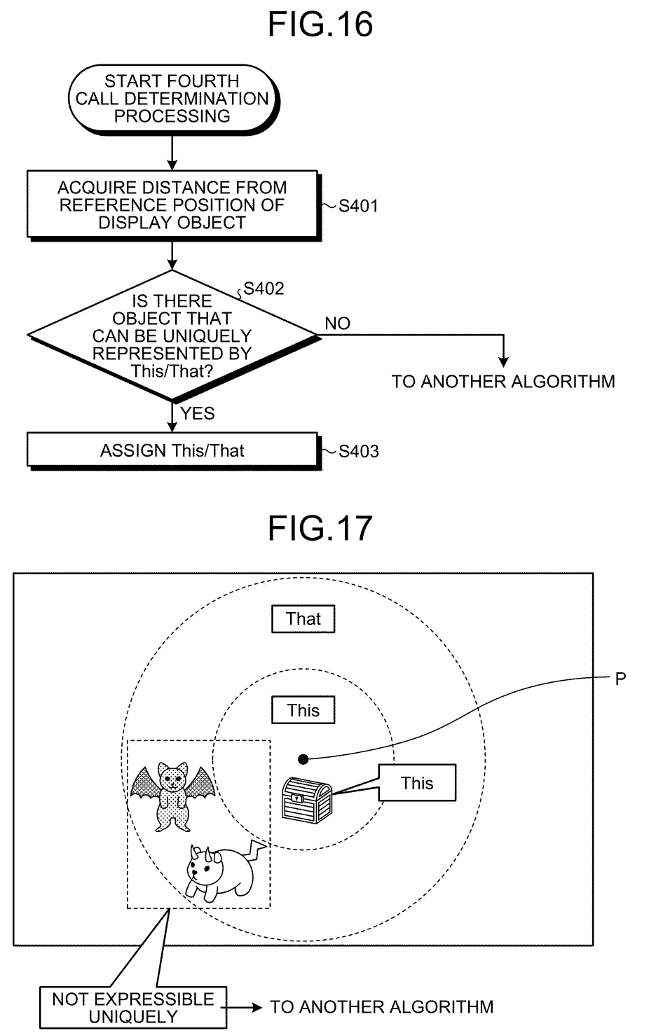

Note that a pronoun (hereinafter, referred to as a “distance reserved word”) including distance nuances such as “this” in the second line of FIG. 3 can be assigned from a spatial distance relationship from a predetermined reference point of the object acquired from the above-described analysis information, a temporal distance relationship from a current time point, or the like. Such an example will be described later in the description of the “fourth call determination processing” using FIGS. 16 to 18 and the like.

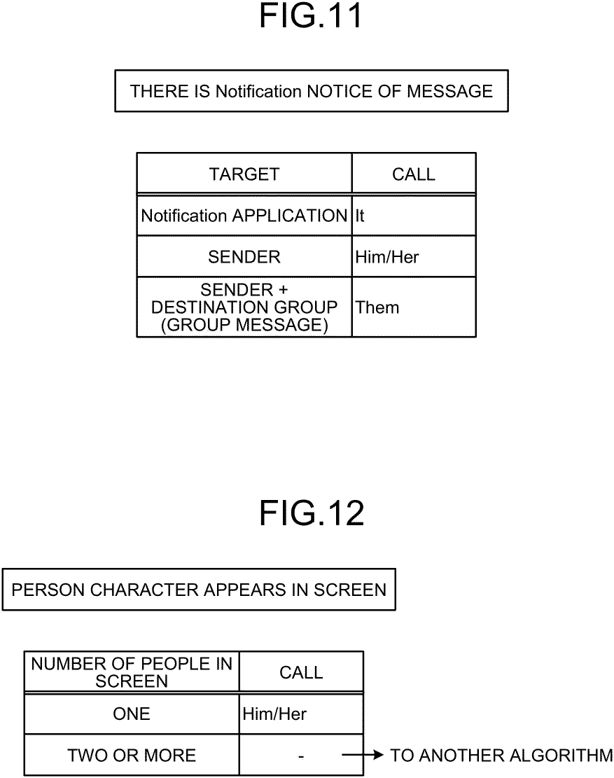

In addition, pronouns (hereinafter, referred to as a “time-series reserved word”) including time-series nuances such as “him” in the third line and “it” in the fifth line in FIG. 3 can be assigned from a time-series change or the like of the object acquired from the above-described analysis information. Such an example will be described later in the description of the “second call determination processing” using FIGS. 10 and 11 and the like.

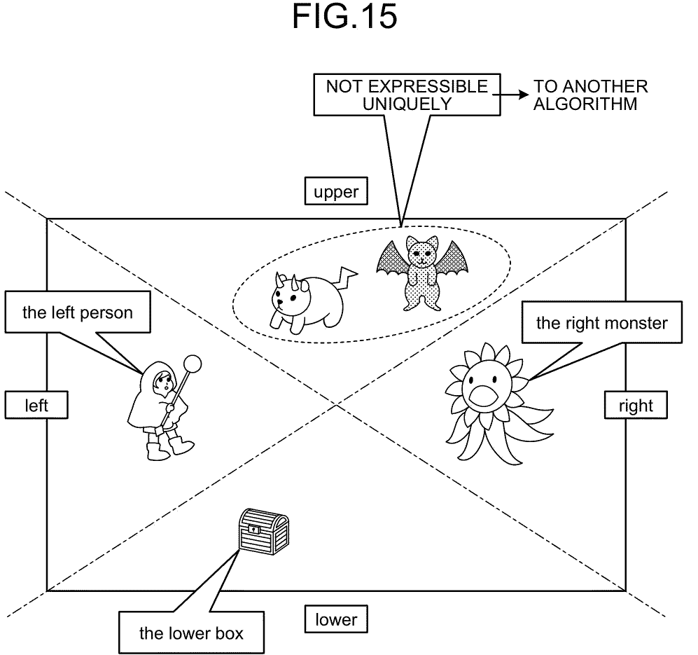

Furthermore, an adjective or the like (hereinafter, referred to as a “positional reserved word”) including positional nuances such as “left” in the fourth line of FIG. 3 can be assigned from a positional relationship or the like of objects acquired from the attribute information or the analysis information described above. Such an example will be described later in the description of the “third call determination processing” using FIGS. 14 and 15 and the like.

As described above, in the information processing method according to the embodiment, the feature value related to the display element that can be the target of the voice command uttered by the user is acquired, and the call of the display element is determined such that the display element is uniquely specified with another display element other than the display element on the basis of the acquired feature value.

Therefore, according to the information processing method according to the embodiment, it is possible to assign a uniquely identifiable call to an object for which general-purpose voice recognition is difficult.

Hereinafter, a configuration example of the information processing system 1 to which the information processing method according to the above-described embodiment is applied will be described more specifically.

### 2. Configuration of Information Processing System

### 2-1. Overall Configuration

FIG. 4 is a diagram illustrating a configuration example of the information processing system 1 according to the embodiment of the present disclosure. As illustrated in FIG. 4, the information processing system 1 includes one or more terminal devices 10 and a server device 100. Furthermore, as illustrated in FIG. 4, the terminal device 10 and the server device 100 are connected to each other by a network N such as the Internet or a mobile telephone network, and transmit and receive data to and from each other via the network N.

The terminal device 10 is a device used by each user, includes a voice UI, and executes various types of information processing according to utterance content of the user via the voice UI. In the present embodiment, the terminal device 10 executes the online RPG and progresses the game according to the voice command uttered by the user.

The terminal device 10 is a desktop personal computer (PC), a notebook PC, a tablet terminal, a mobile phone, a personal digital assistant (PDA), or the like. Furthermore, the terminal device 10 may be, for example, a robot that interacts with the user, a wearable terminal worn by the user, a navigation device mounted on a vehicle, or the like.

The server device 100 is a server device that provides an online RPG service to each terminal device 10 via the network N. The server device 100 collects a progress status of the game transmitted from each terminal device 10.

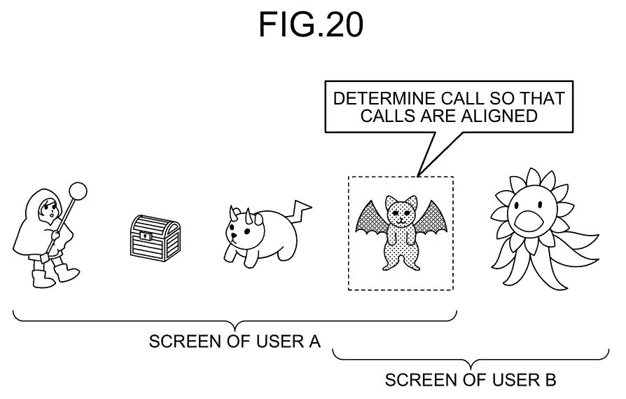

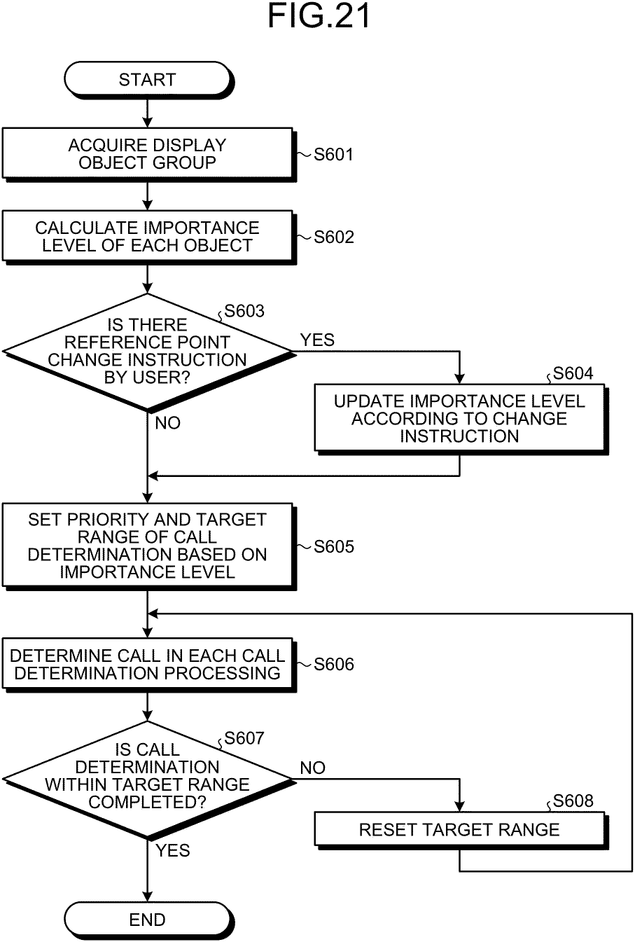

Furthermore, the server device 100 can assign a common call (hereinafter, referred to as a “common call”) to the same object simultaneously viewed by a plurality of users on the basis of the collected progress status or the like. Such an example will be described later in the description of the “fifth call determination processing” using FIGS. 19 and 20 and the like.

### 2-2. Configuration of Terminal Device

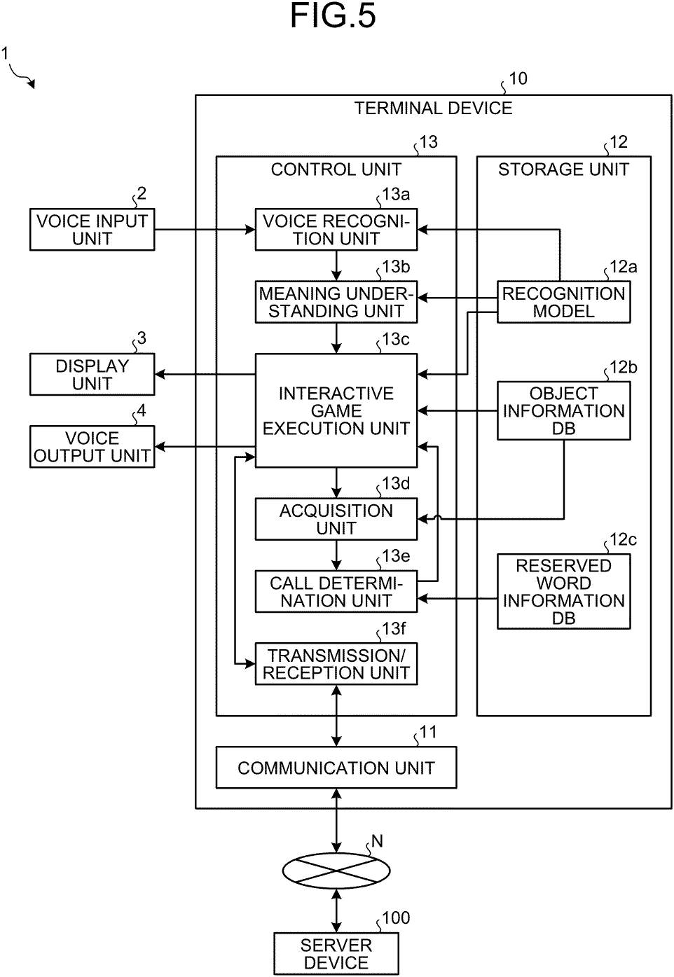

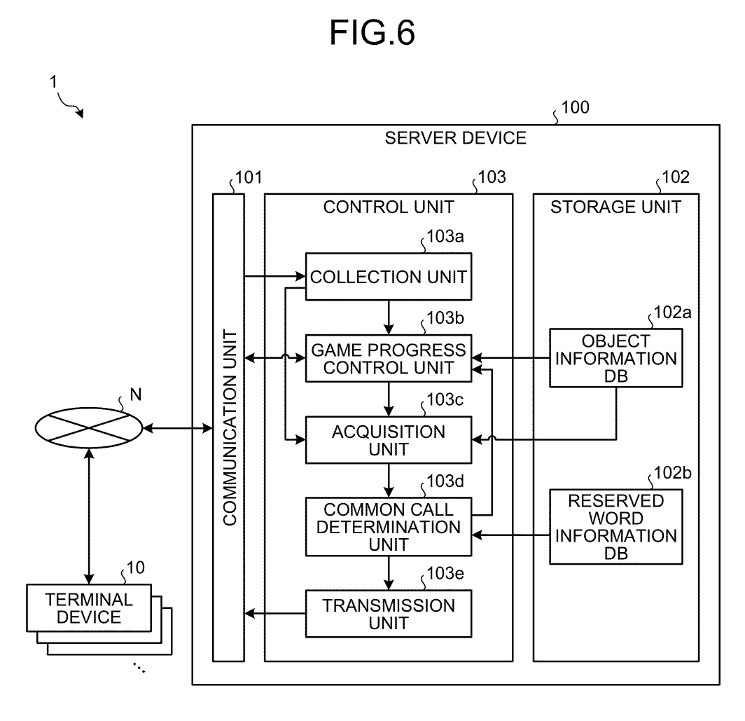

Next, FIG. 5 is a block diagram illustrating a configuration example of the terminal device 10. In FIG. 5 (and FIG. 6 illustrated later), only components necessary for describing features of the embodiment are illustrated, and descriptions of general components are omitted.

In other words, each component illustrated in FIG. 5 (and FIG. 6) is functionally conceptual, and does not necessarily have to be physically configured as illustrated. For example, a specific form of distribution and integration of each block is not limited to the illustrated form, and all or a part thereof can be functionally or physically distributed and integrated in an arbitrary unit according to various loads, usage conditions, and the like.

In the description using FIG. 5 (and FIG. 6), the description of the already described components may be simplified or omitted.

As illustrated in FIG. 5, a voice input unit 2, a display unit 3, and a voice output unit 4 are connected to the terminal device 10. The voice input unit 2 is realized by a voice input device such as a microphone. The display unit 3 is realized by an image output device such as a display. The voice output unit 4 is realized by a voice output device such as a speaker.

The terminal device 10 includes a communication unit 11, a storage unit 12, and a control unit 13. The communication unit 11 is realized by, for example, a network interface card (NIC) or the like. The communication unit 11 is connected to the server device 100 in a wireless or wired manner via the network N, and transmits and receives information to and from the server device 100.

The storage unit 12 is realized by, for example, a semiconductor memory element such as a random access memory (RAM), a read only memory (ROM), or a flash memory, or a storage device such as a hard disk or an optical disk. In the example illustrated in FIG. 5, storage unit 12 stores recognition model 12a, object information DB (database) 12b, and reserved word information DB 12c.

The recognition model 12a is a model group for voice recognition in automatic voice recognition (ASR) processing to be described later, meaning understanding in natural language understanding (NLU) processing, dialogue recognition in interactive game execution processing, and the like, and is generated by the server device 100 as a learning model group using a machine learning algorithm such as deep learning, for example. The recognition model 12a corresponds to the general-purpose voice recognition engine described above.

The object information DB 12b is a database of information regarding each object displayed on the game screen, and includes attribute information of each object described above.

The reserved word information DB 12c is a database of information regarding reserved words, and includes definition information of each reserved word such as the above-described distance reserved word, time-series reserved word, and positional reserved word.

The control unit 13 is a controller, and is implemented by, for example, a central processing unit (CPU), a micro processing unit (MPU), or the like executing various programs stored in the storage unit 12 using a RAM as a work area. Furthermore, the control unit 13 can be realized by, for example, an integrated circuit such as an application specific integrated circuit (ASIC) or a field programmable gate array (FPGA).

The control unit 13 includes a voice recognition unit 13a, a meaning understanding unit 13b, an interactive game execution unit 13c, an acquisition unit 13d, a call determination unit 13e, and a transmission/reception unit 13f, and realizes or executes a function and an action of information processing described below.

The voice recognition unit 13a performs the ASR processing on the voice data input from the voice input unit 2, and converts the voice data into text data. Furthermore, the voice recognition unit 13a outputs the converted text data to the meaning understanding unit 13b.

The meaning understanding unit 13b performs meaning understanding processing such as NLU processing on the text data converted by the voice recognition unit 13a, and outputs a processing result to the interactive game execution unit 13c.

The interactive game execution unit 13c executes the game on the basis of the processing result of the meaning understanding unit 13b. Specifically, the interactive game execution unit 13c generates image information and voice information to be presented to the user on the basis of the processing result of the meaning understanding unit 13b.

In addition, the interactive game execution unit 13c presents the generated image information to the user via the display unit 3, performs voice synthesis processing on the generated voice information, and presents the generated voice information to the user via the voice output unit 4 to advance the game.

The acquisition unit 13d acquires attribute information including a property value that is an attribute value of each object from the object information DB 12b. In addition, the acquisition unit 13d appropriately acquires image information being presented to the user from the interactive game execution unit 13c.

In addition, the acquisition unit 13d performs image analysis on the acquired image information, and acquires a dynamic state value of each object being displayed. In addition, the acquisition unit 13d outputs the acquired state value of each object to the call determination unit 13e.

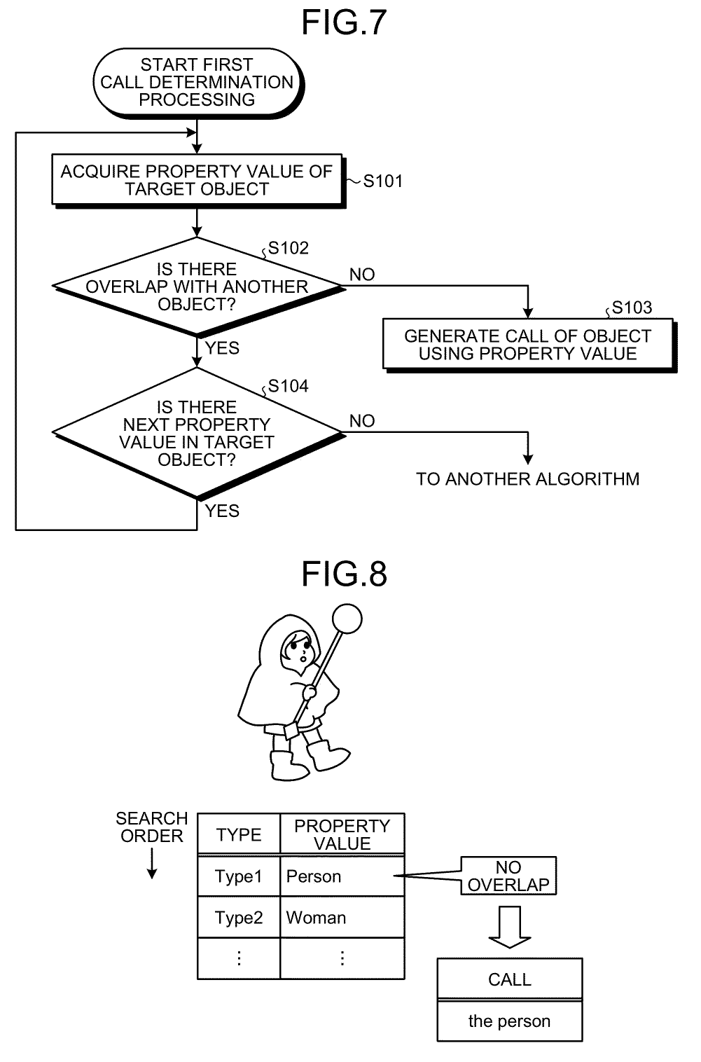

The call determination unit 13e executes call determination processing of determining the call of each object so that each object is uniquely specified on the basis of the attribute value and/or the state value of each object acquired by the acquisition unit 13d. Here, the call determination unit 13e can execute first call determination processing to fourth call determination processing. Specific contents of these processes will be described later with reference to FIG. 7 and subsequent drawings.

In addition, the call determination unit 13e appropriately outputs the determined call of each object to the interactive game execution unit 13c, and the interactive game execution unit 13c causes the game to proceed while specifying each object on the basis of the call determined by the call determination unit 13e.

The transmission/reception unit 13f transmits the progress status of the game output by the interactive game execution unit 13c to the server device 100 via the communication unit 11 as needed. In addition, the transmission/reception unit 13f receives the common call transmitted from the server device 100 via the communication unit 11, and appropriately outputs the common call to the interactive game execution unit 13c. The interactive game execution unit 13c causes the game to proceed while specifying each object on the basis of the common call received by the transmission/reception unit 13f.

### 2-3. Configuration of Server Device

Next, a configuration example of the server device 100 will be described. FIG. 6 is a block diagram illustrating a configuration example of the server device 100.

As illustrated in FIG. 6, the server device 100 includes a communication unit 101, a storage unit 102, and a control unit 103. Similarly to the communication unit 11 described above, the communication unit 101 is realized by, for example, an NIC or the like. The communication unit 101 is connected to each of the terminal devices 10 in a wireless or wired manner via the network N, and transmits and receives information to and from the terminal device 10.

Similarly to the storage unit 12 described above, the storage unit 102 is realized by, for example, a semiconductor memory element such as a RAM, a ROM, or a flash memory, or a storage device such as a hard disk or an optical disk. In the example illustrated in FIG. 6, the storage unit 102 stores an object information DB 102a and a reserved word information DB 102b.

The object information DB 102a is similar to the object information DB 12b described above. The reserved word information DB 102b is similar to the reserved word information DB 12c described above.

Similarly to the control unit 13 described above, the control unit 103 is a controller, and is implemented by, for example, a CPU, an MPU, or the like executing various programs stored in the storage unit 102 using a RAM as a work area. Furthermore, similarly to the control unit 13 described above, the control unit 103 can be realized by, for example, an integrated circuit such as an ASIC or an FPGA.

The control unit 103 includes a collection unit 103a, a game progress control unit 103b, an acquisition unit 103c, a common call determination unit 103d, and a transmission unit 103e, and realizes or executes a function and an action of information processing described below.

The collection unit 103a collects the progress status of the game from each terminal device 10 via the communication unit 101 and outputs the progress status to the game progress control unit 103b. The game progress control unit 103b controls the progress of the game in each terminal device 10 via the communication unit 101 on the basis of the progress status collected by the collection unit 103a.

When the common call determination unit 103d determines the common call, the acquisition unit 103c acquires the attribute information including the attribute value of each object from the object information DB 102a. Furthermore, the acquisition unit 103c appropriately acquires image information being presented to each user from the game progress control unit 103b.

Furthermore, the acquisition unit 103c performs image analysis on the acquired image information, and acquires a dynamic state value of each object being displayed to each user from the analysis information. In addition, the acquisition unit 13d outputs the acquired state value of each object to the common call determination unit 103d.

On the basis of the attribute value and/or the state value of each object acquired by the acquisition unit 103c, the common call determination unit 103d executes fifth call determination processing of determining a common call so that each object is uniquely specified between users. Specific content of the fifth call determination processing will be described later with reference to FIGS. 19 and 20.

In addition, the common call determination unit 103d appropriately outputs the determined common call to the game progress control unit 103b, and the game progress control unit 103b controls the progress of the game while specifying each object common between the users on the basis of the common call determined by the common call determination unit 103d.

In addition, the common call determination unit 103d outputs the determined common call to the transmission unit 103e. The transmission unit 103e transmits the common call determined by the common call determination unit 103d to the corresponding terminal device 10 via the communication unit 101.

### 2-4. Specific Example of Call Determination Processing

Next, a specific example of the call determination processing executed by the call determination unit 13e will be described with reference to FIGS. 7 to 18.

### 21. Specific Example of First Call Determination Processing

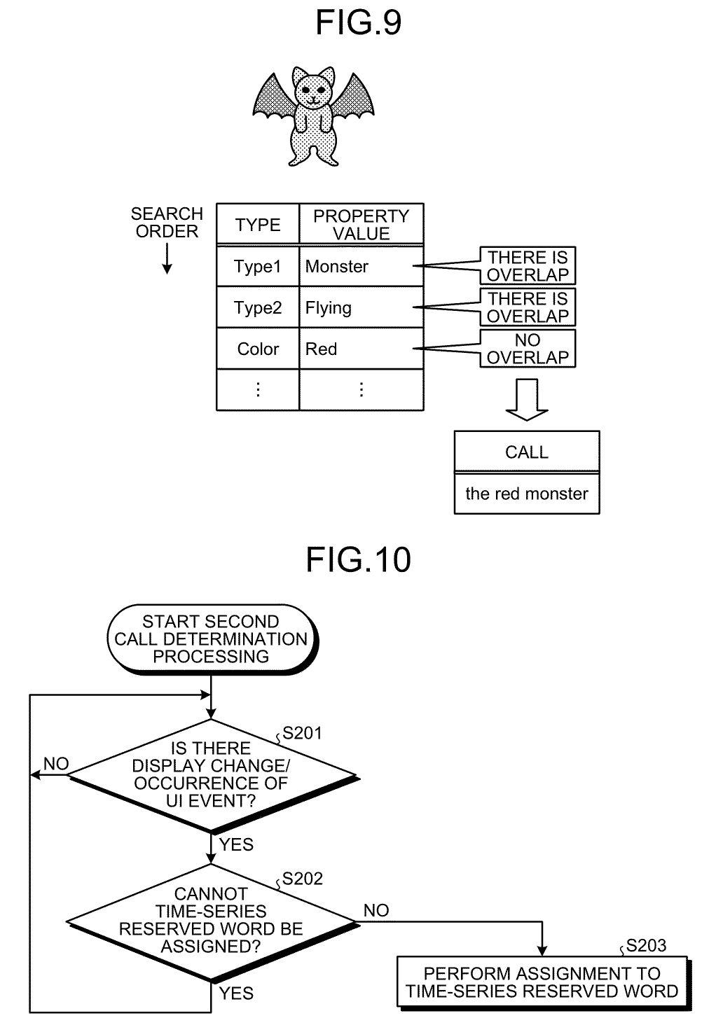

FIG. 7 is a flowchart illustrating a processing procedure of the first call determination processing. FIG. 8 is a diagram (part 1) illustrating a call determination example by the first call determination processing. FIG. 9 is a diagram (part 2) illustrating the call determination example by the first call determination processing.

In the first call determination processing, the property values of the respective objects are compared, uniqueness is secured by using the non-overlapping property values, and the call of the target object is determined.

Specifically, as illustrated in FIG. 7, in the first call determination processing, the call determination unit 13e first acquires the property value of the target object (Step S101). Then, it is determined whether or not the acquired property value overlaps, for example, another object being displayed (Step S102).

Here, in a case where there is no overlap (Step S102, No), the call determination unit 13e generates the call of the object using the property value (Step S103). On the other hand, in a case where there is the overlap (Step S102, Yes), the call determination unit 13e determines whether or not there is the next property value in the target object (Step S104).

Here, in a case where there is the next property value (Step S104, Yes), the call determination unit 13e repeats the processing from Step S101. In addition, in a case where there is no next property value (Step S104, No), the call determination unit 13e proceeds to another algorithm in the call determination processing.

More specifically, as illustrated in FIG. 8, in the first call determination processing, for example, the property value of the target object is searched in a predetermined search order, and it is determined whether or not there is an overlap with another object for each type. Then, as in the example of FIG. 8, if there is no overlap in “Person”, this is used, for example, to call “the person”.

Furthermore, as illustrated in FIG. 9, in the first call determination processing, for example, if there is the overlap, the property value of the target object is searched until there is no overlap or there is no property value. Then, as in the example of FIG. 9, if there is no overlap in “Red”, this is used, for example, to call “the red monster”. Note that the call may be determined as “the red” or “the red one” as long as it can be uniquely specified.

Note that, in FIGS. 7 to 9, an example based on the property value as the attribute value has been described, but the dynamic state value included in the analysis information described above may be used. For example, as a result of image analysis, a rough color of each object is acquired as a state value, and processing similar to that in FIGS. 7 to 9 can be performed depending on whether or not the state values overlap.

Furthermore, in FIGS. 7 to 9, the presence or absence of the overlap is determined by comparing single property values, but the presence or absence of the overlap may be determined by a combination of a plurality of property values.

### 22. Specific Example of Second Call Determination Processing

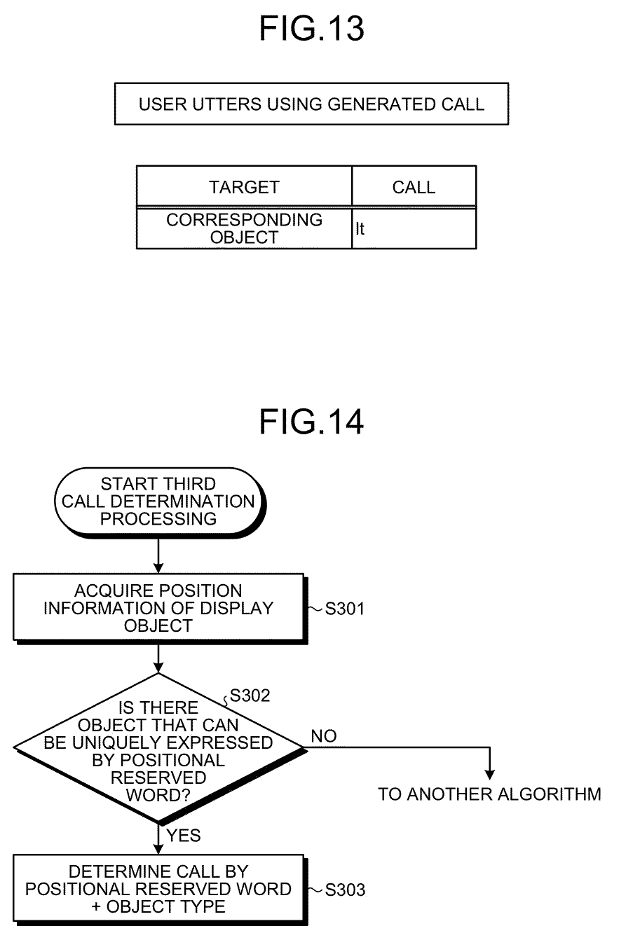

Next, FIG. 10 is a flowchart illustrating a processing procedure of the second call determination processing. In addition, FIG. 11 is a diagram (part 1) illustrating a call determination example by the second call determination processing. In addition, FIG. 12 is a diagram (part 2) illustrating the call determination example by the second call determination processing. In addition, FIG. 13 is a diagram (part 3) illustrating the call determination example by the second call determination processing.

In the second call determination processing, a call is determined by assigning a time-series reserved word on the basis of a time-series change in a display object, a UI event, or the like. Here, the time-series reserved word is, for example, “It”, “Him”, “Her”, “Them”, or the like.

Specifically, as illustrated in FIG. 10, in the second call determination processing, the call determination unit 13e determines whether there is a display change of the display object in the screen or occurrence of a UI event (Step S201). Note that, in a case where there is no display change or occurrence of a UI event (Step S201, No), Step S201 is repeated.

Here, in a case where there is a display change or an occurrence of a UI event (Step S201, Yes), the call determination unit 13e determines whether the time-series reserved word cannot be assigned (Step S202).

When the assignment to the time-series reserved word is possible (Step S202, No), the call determination unit 13e performs the assignment to the time-series reserved word (Step S203). When the assignment to the time-series reserved word is impossible (Step S202, Yes), the call determination unit 13e repeats the processing from Step S201.

More specifically, as illustrated in FIG. 11, in the second call determination processing, when there is a Notification notice of a message in the game, the call determination unit 13e assigns “It” as a call to the Notification application, for example. As a result, the Notification notice can be opened via the Notification UI by uttering “Show it”, for example.

Furthermore, as illustrated in FIG. 11, the call determination unit 13e assigns “Him” or “Her” as the call to the sender of the Notification notice, for example. Furthermore, in a case where the Notification notice is a group message, the call determination unit 13e assigns “Them” as a call to the sender and the destination group, for example.

Furthermore, as illustrated in FIG. 12, in the second call determination processing, for example, in a case where a person character appears in the screen, if the number of people in the screen of the person character other than the user is one, the call determination unit 13e assigns “Him” or “Her” as the call to the person character. Note that, in a case where there are two or more persons, the call determination unit 13e proceeds to another algorithm in the call determination processing.

Furthermore, as illustrated in FIG. 13, in the second call determination processing, for example, in a case where the user utters using the generated call, the call determination unit 13e subsequently assigns “It” to the corresponding object as the call.

By this second call determination processing, each object can be uniquely specified by an appropriate pronoun according to a time-series change.

### 23. Specific Example of Third Call Determination Processing

Next, FIG. 14 is a flowchart illustrating a processing procedure of the third call determination processing. In addition, FIG. 15 is a diagram illustrating a call determination example by the third call determination processing.

In the third call determination processing, uniqueness is secured by the positional reserved word from the positional relationship of each object, and the call of each object is determined. Here, the positional reserved word is, for example, “left”, “right”, “upper”, “lower”, or the like.

Specifically, as illustrated in FIG. 14, in the third call determination processing, the call determination unit 13e first acquires the position information of the display object being displayed (Step S301). Then, based on the acquired position information, it is determined whether or not there is an object that can be uniquely expressed by the positional reserved word (Step S302).

Here, in a case where there is an expressible object (Step S302, Yes), the call determination unit 13e determines the call by, for example, the positional reserved word and the object type (Step S303). Meanwhile, in a case where there is no expressible object (Step S302, No), the call determination unit 13e proceeds to another algorithm in the call determination processing.

More specifically, as illustrated in FIG. 15, in the third call determination processing, for example, the game screen is divided into four areas corresponding to “left”, “right”, “upper”, and “lower”, and it is determined whether or not the object in each area can be uniquely expressed using the positional reserved word.

Then, if the expression is possible, the call is determined using the object type and the positional reserved word. In the example of FIG. 15, the character of the person in the area “left” is called “the left person”. Further, the monster in the area “right” is called “the right monster”. Further, an item in the area “lower” is called “the lower box”.

In addition, since the area “upper” cannot be uniquely expressed, the algorithm shifts to another algorithm.

Note that, in the example of FIG. 15, an example has been described in which the call is uniquely specified from a two-dimensional positional relationship; however, a three-dimensional positional relationship may be used. In this case, “front”, “back”, and the like are used as the positional reserved word.

### 24. Specific Example of Fourth Call Determination Processing

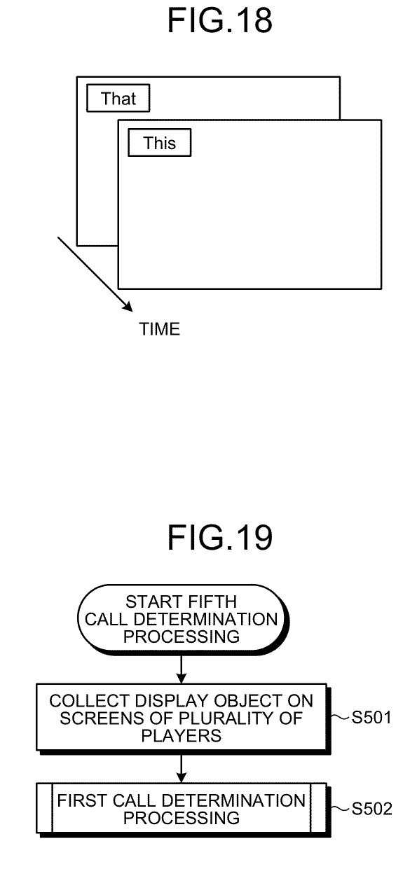

Next, FIG. 16 is a flowchart illustrating a processing procedure of the fourth call determination processing. FIG. 17 is a diagram (part 1) illustrating a call determination example by the fourth call determination processing. In addition, FIG. 18 is a diagram (part 2) illustrating the call determination example by the fourth call determination processing.

In the fourth call determination processing, the uniqueness is secured by the distance reserved word on the basis of the spatial distance relationship from the predetermined point of each object or the temporal distance relationship from the current time point, and the call of each object is determined. Here, the distance reserved word is, for example, “This”, “That”, or the like. “It” already mentioned as the time-series reserved word may be used as the distance reserved word.

Specifically, as illustrated in FIG. 16, in the fourth call determination processing, the call determination unit 13e first acquires the distance from the predetermined reference position of the display object being displayed (Step S401). Then, based on the acquired distance, it is determined whether there is an object that can be uniquely expressed by the distance reserved word of “This” or “That” (Step S402).

Here, in a case where there is an expressible object (Step S402, Yes), the call determination unit 13e determines the call by “This” or “That” (Step S403). Meanwhile, in a case where there is no expressible object (Step S402, No), the call determination unit 13e proceeds to another algorithm in the call determination processing.

More specifically, as illustrated in FIG. 17, in the fourth call determination processing, for example, a predetermined reference point P is set on the game screen, and areas “This” and “That” concentric with the reference point P as the center are provided. The area closer to the reference point P (that is, the distance is shorter) is the area “This”. The other is the area “That”.

Then, in the fourth call determination processing, it is determined whether or not the object can be uniquely expressed using the distance reserved word in each area.

Then, when it is expressible, the area name “This” or “That” of the corresponding area is assigned as the call. In the example of FIG. 17, the item in the area “This” is called “This”. Furthermore, since the area “That” cannot be uniquely expressed, the algorithm shifts to another algorithm.

Furthermore, as illustrated in FIG. 18, in the fourth call determination processing, it is also possible to assign the distance reserved word on the basis of a time-series distance relationship from the current time point, in other words, a temporal context relationship. That is, as illustrated in FIG. 18, the uniqueness may be ensured by assigning “This” to the currently displayed object and “That” to the temporally previously displayed object.

### 2-5. Specific Example of Common Call Determination Processing (Fifth Call Determination Processing)

Next, a specific example of the common call determination processing will be described with reference to FIGS. 19 and 20. FIG. 20 is a flowchart illustrating a processing procedure of the fifth call determination processing. FIG. 20 is a processing explanatory diagram of the fifth call determination processing.

In the fifth call determination processing, the server device 100 determines the common call so that the call is made by necessary players so that the call does not deviate between the players in the online chat or the like.

Specifically, as illustrated in FIG. 19, in the fifth call determination processing, the collection unit 103a collects display objects on screens of a plurality of players (Step S501). Here, as illustrated in FIG. 20, in a case where an object being displayed on a screen of a user A and an object being displayed on a screen of a user B are collected, in the fifth call determination processing, these objects are integrated, and the call is determined so that the calls of the monsters surrounded by a dashed-line rectangle common to at least both the screens are aligned. Note that, in the fifth call determination processing, it goes without saying that the call is determined so that uniqueness is ensured in each of the screen of the user A and the screen of the user B.

The description returns to FIG. 19. Then, the common call determination unit 103d determines the call of the corresponding object, for example, by executing the first call determination processing described above (Step S502). Note that, in the fifth call determination processing, a range in which the objects are integrated is a range that satisfies a certain condition such as “belonging to the same party” or “belonging to the same chat”.

Furthermore, even users who are not in the same group at the current time point may be given the same call as much as possible to users who are in the same group at a certain high frequency or more. In addition, an object displayed only for some users may also be processed as a determination target of the common call.

In addition, since the same monsters and items in the screen are displayed without depending on the player, the same monsters and items may be subjected to the common call as shared objects and integrated.

Furthermore, it is preferable that the Notification notice or the like displayed to each individual user is not a target of the integration processing as a sharing prohibited personal object. In addition, the same applies to the fact that the call already assigned as the call to the individual object is not used as the common call.

### 2-6. Target Range and The Like of Call Assignment

By the way, the target range of the call assignment may be set according to the importance level of each object, for example. Furthermore, in such a target range, for example, priority may be determined according to the importance level of each object, and the order of assignment may be set. Furthermore, for example, the importance level may be recalculated on the basis of a change instruction by a voice command of the user, and the target range may be appropriately changed.

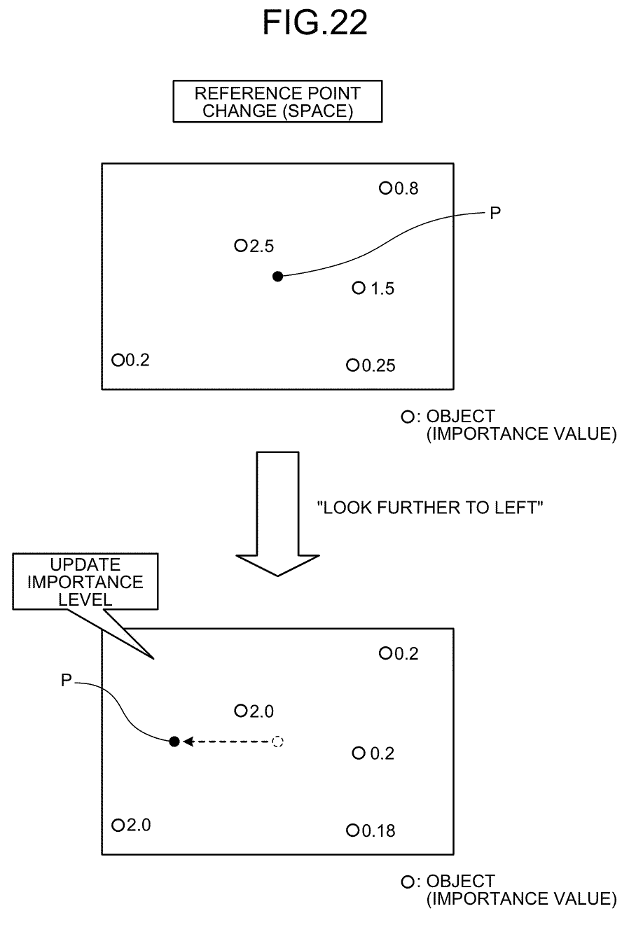

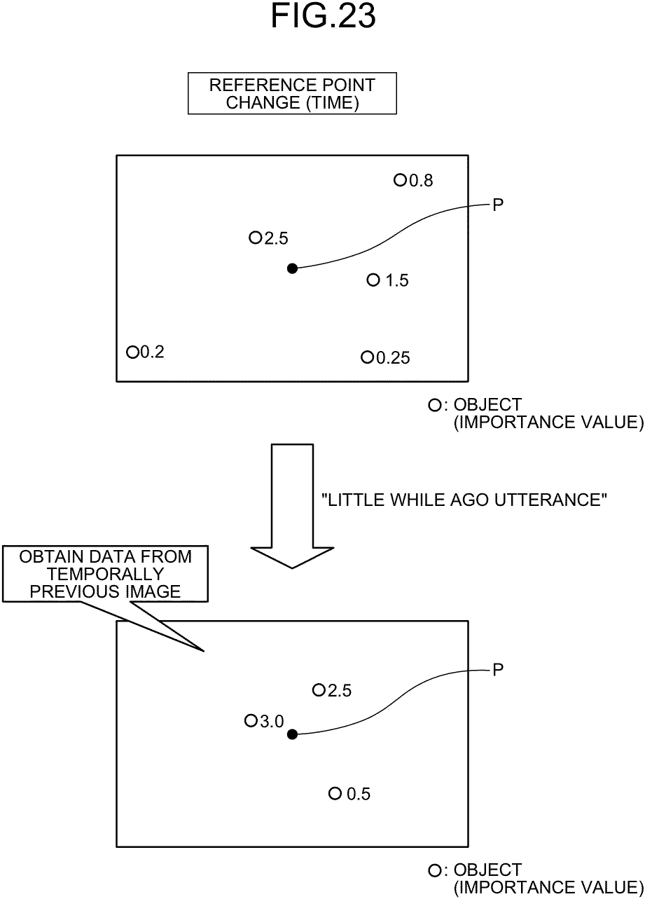

Next, these specific examples will be described. FIG. 21 is a flowchart illustrating a processing procedure of the call determination processing in a case where the target range of call assignment is set. FIG. 22 is an explanatory diagram (part 1) in a case where there is a user’s instruction to change the reference point for determining an importance level. FIG. 23 is an explanatory diagram (part 2) in a case where there is the user’s instruction to change the reference point for determining the importance level.

In a case of setting the target range of the call assignment, as illustrated in FIG. 21, the call determination unit 13e acquires a display object group (Step S601). Then, the call determination unit 13e calculates the importance level of each object (Step S602).

Here, the importance level is, for example, a spatial distance from a predetermined reference point P. The importance level is calculated to be higher as the distance is shorter, for example.

Then, it is determined whether there is a reference point change instruction by the user (Step S603). Here, when there is the change instruction (Step S603, Yes), the call determination unit 13e updates the importance level according to the change instruction (Step S604). When there is no change instruction (Step S603, No), the process proceeds to Step S605.

More specifically, for example, in the case of a spatial reference point change instruction, it is assumed that the importance level of each object being displayed is calculated based on the distance from the reference point P as illustrated in the upper part of FIG. 22. The reference point P mentioned here corresponds to, for example, the viewpoint position of the user in the game space.

Then, here, it is assumed that a voice command “look farther to the left” is uttered from the user. Then, as illustrated in the lower part of FIG. 22, the reference point P moves to the left. In such a case, the call determination unit 13e recalculates the importance level of each object according to the position of the reference point P after the movement, and updates the importance level.

The reference point change instruction can also be applied to, for example, a temporal reference point (for example, the current time point). As illustrated in FIG. 23, for example, it is assumed that the user has uttered “a little while ago”. Then, as illustrated in the lower part of FIG. 23, data is acquired from the temporally previous image, and the call determination unit 13e updates the importance level by acquiring the importance level from each object of the temporally previous image.

The description returns to FIG. 21. Then, the call determination unit 13e sets the priority and the target range of call determination on the basis of the calculated or updated importance level (Step S605), and determines the call in each call determination processing described above (Step S606).

Note that, in Step S605, the priority is set by, for example, sorting by importance level. The target range is set by a predetermined threshold, a number limit, or the like with respect to the importance level.

Then, it is determined whether or not the call determination within the target range has been completed (Step S607), and in a case where the call determination has been completed (Step S607, Yes), the processing ends. In addition, in a case where the processing has not been completed (Step S607, No), the target range is reset by changing the threshold, the number limit, or the like (Step S608), and the processing from Step S606 is repeated.

### 2-7. Connection or Combination of Call Determination Processing

Meanwhile, the call determination processing described so far may be appropriately connected or may be appropriately combined. In the case of connection, the order may be statically fixed or may be dynamically changed according to the game situation.

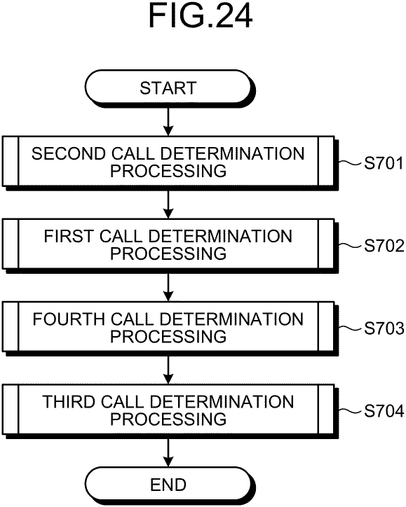

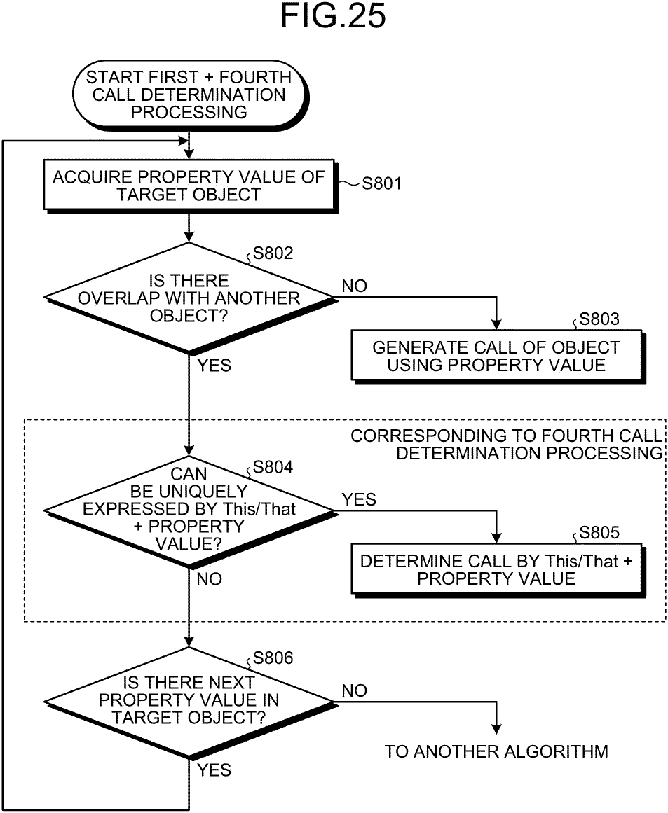

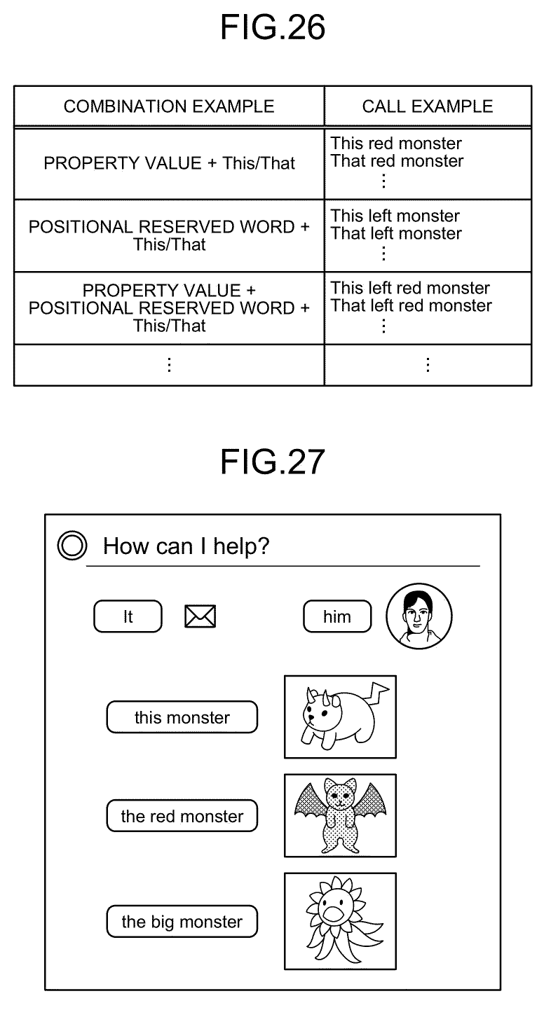

Next, a specific example of such a case will be described. FIG. 24 is a flowchart illustrating a processing procedure of an example in a case where each call determination processing is connected. FIG. 25 is a flowchart illustrating a processing procedure of an example in a case where the call determination processing is combined. In addition, FIG. 26 is a diagram illustrating a call example in each combination example.

As illustrated in FIG. 24, the call determination unit 13e may connect the call determination processing so as to be executed in the order of the second call determination processing (Step S701), the first call determination processing (Step S702), the fourth call determination processing (Step S703), and the third call determination processing (Step S701).

The example illustrated in FIG. 24 is an example in which the property value of the object is prioritized, and is effective in the case of a game or the like having a large positional change or viewpoint change. Note that, in a case where the call cannot be finally determined, the call may be determined by assigning an index number according to a predetermined rule or the like.

In addition, as illustrated in FIG. 25, the call determination unit 13e may combine the call determination processing, for example, as in the first call determination processing and the fourth call determination process. When combining the first call determination processing and the fourth call determination processing, as illustrated in FIG. 25, the call determination unit 13e first acquires the property value of the target object (Step S801). Then, it is determined whether or not the acquired property value overlaps, for example, another object being displayed (Step S802).

Here, in a case where there is no overlap (Step S802, No), the call determination unit 13e generates the call of the object using the property value (Step S803). Meanwhile, in a case where there is the overlap (Step S802, Yes), the call determination unit 13e determines whether or not it can be uniquely expressed by “This” or “That” + property value (Step S804).

Here, in a case where expression is possible (Step S804, Yes), the call determination unit 13e determines the call by “This” or “That” + the property value (Step S805). Meanwhile, when the expression cannot be expressed (Step S804, No), the call determination unit 13e determines whether the target object has the next property value (Step S806).

Here, in a case where there is the next property value (Step S806, Yes), the call determination unit 13e repeats the processing from Step S801. In addition, in a case where there is no next property value (Step S806, No), the call determination unit 13e proceeds to another algorithm.

Note that, in FIG. 25, portions in Steps S804 and S805 correspond to the fourth call determination processing, and portions in other Steps correspond to the first call determination processing.

FIG. 26 illustrates a call example in each combination example. For example, in a combination of the property value + This/That, the call example is “This red monster”, “That red monster”, or the like.

Furthermore, for example, in a combination of the positional reserved word + This/That, the call example is “This left monster”, “That left monster”, or the like. Furthermore, for example, in a combination of the property value + the positional reserved word + This/That, the call example is “This left red monster”, “That left red monster”, or the like.

### 2-8. Display Example of Call

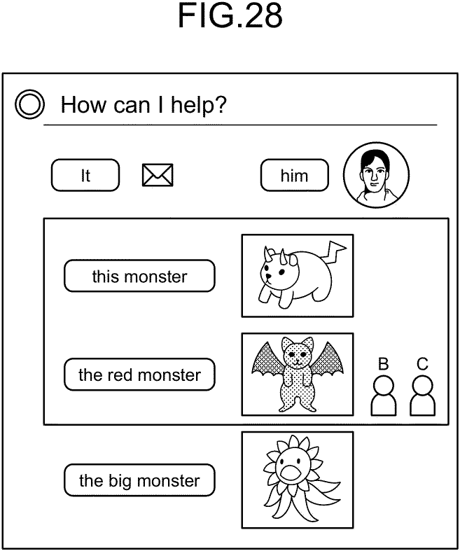

Meanwhile, the call determined by each call determination processing described so far can be presented to the user by being displayed in the game screen. Such display examples are illustrated in FIGS. 27 to 29. FIG. 27 is a diagram (part 1) illustrating a display example in a voice UI screen. FIG. 28 is a diagram (part 2) illustrating the display example in the voice UI screen. FIG. 29 is a diagram illustrating a display example in a game screen.

Note that the voice UI screens in FIGS. 27 and 28 are called by, for example, a predetermined wake-up word or the like. As illustrated in FIGS. 27 and 28, each call determined by each call determination processing is displayed in association with each object on the voice UI screen. As a result, for example, even when the user does not know the name of the monster, the user can utter the voice command for the monster who does not know the name by confirming the display of the call.

Furthermore, as illustrated in FIG. 28, for example, an object that is seen by another user (here, users A and B) may be displayed to be clearly distinguished from other objects so that the object that is seen by another user can be clearly understood.

In this manner, by visualizing what other users see, it is possible to easily determine availability at the time of communication such as online chat.

Furthermore, as illustrated in FIG. 29, in the game screen, the determined call may be displayed in a temporary tool-chip format. As a result, for example, even in a case where the display change of the screen is severe and the call is likely to change following the change, the call can be appropriately presented to the user according to the change.

### 3. Modifications

Note that the case where the information processing system 1 according to the embodiment is the game system that provides an online RPG service has been described as a main example heretofore, but the present embodiment is not limited thereto, and can be applied to various other use cases.

### 3-1. Application Example to Another Use Cases

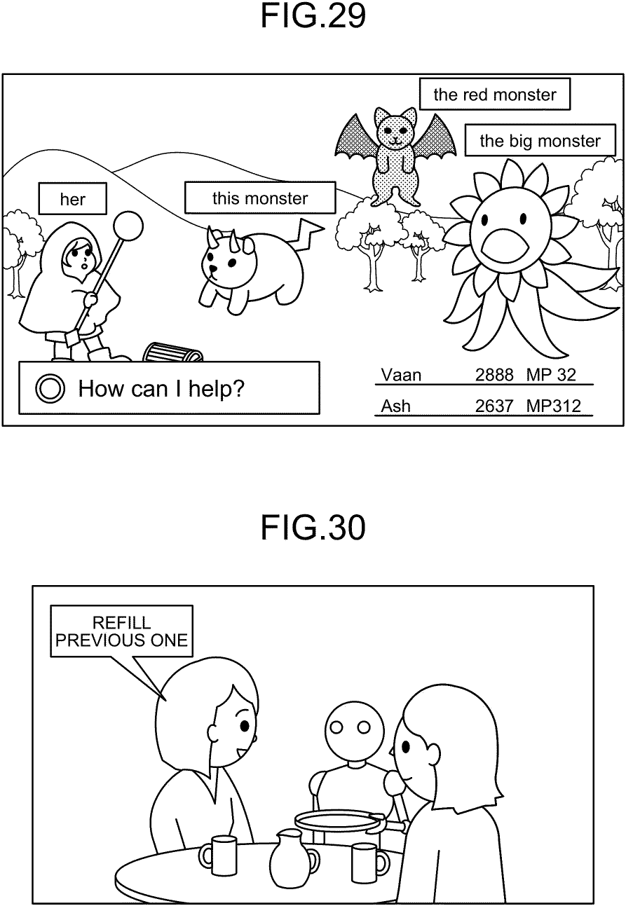

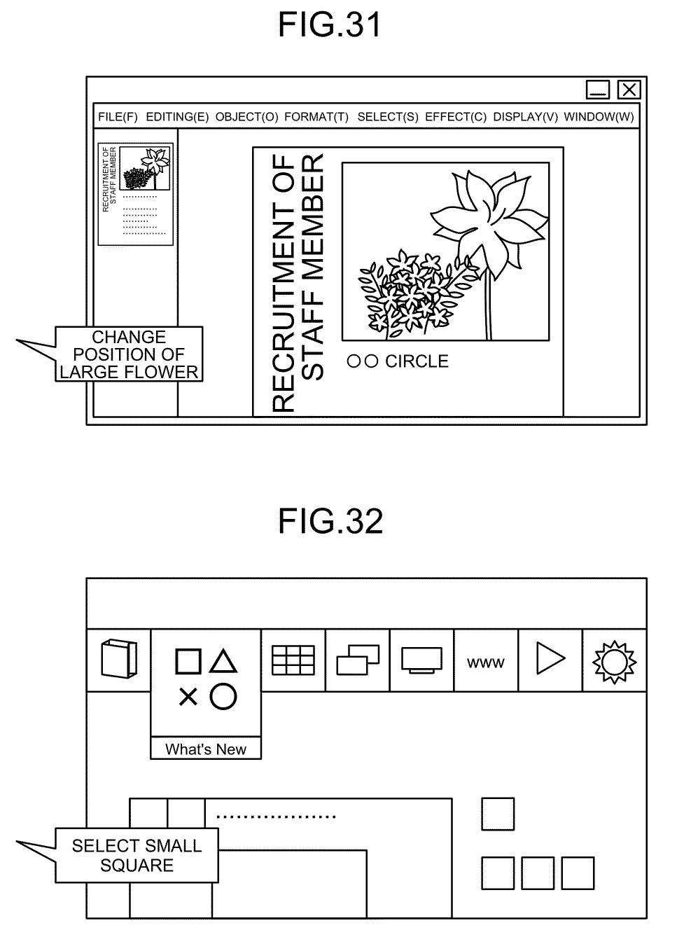

FIG. 30 is a diagram (part 1) illustrating an application example to another use case. FIG. 31 is a diagram (part 2) illustrating an application example to another use case. FIG. 32 is a diagram (part 3) illustrating an application example to another use case. FIG. 33 is a diagram (part 4) illustrating an application example to another use case.

As illustrated in FIG. 30, for example, the terminal device 10 may be a robot or the like that provides a serving service. In such a case, as illustrated in FIG. 30, for example, a voice command such as “refill the previous one” can be uttered by the second call determination processing, the fourth call determination processing, or the like.

Furthermore, as illustrated in FIG. 31, for example, the present technology may be applied to a case where document creation or the like is performed via a voice UI using the terminal device 10. In such a case, as illustrated in FIG. 31, for example, a voice command such as “change the position of a large flower” can be uttered by the first call determination processing or the like.

Furthermore, as illustrated in FIG. 32, for example, the present invention may be applied to a case where the terminal device 10 is a game machine and the UI operation is performed via a voice UI. In such a case, as illustrated in FIG. 32, for example, it is possible to utter a voice command such as “select a small square” in the first call determination processing or the like. Note that a procedure may be employed in which the same name is given to a plurality of objects, and in a case where the objects are uttered, the objects are further stepwisely selected by the user.

Furthermore, as illustrated in FIG. 33, for example, the present invention may be applied to a case where the terminal device 10 is a navigation device such as an augmented reality (AR) navigation device and designates an item or an object on the screen.

For example, in a case where the vehicle is an autonomous driving vehicle and the user desires to follow and travel another vehicle visually recognized from the AR navigation system, or the like, it is possible to utter a voice command such as “following the red car that has just run” as illustrated in FIG. 33 by the first call determination processing to the fourth call determination processing and connection and combination thereof. At this time, the attribute information of the object may be obtained from characteristics such as a shape, or a behavior or a state such as stopping, moving, or turning, and a transition thereof may be used.

Furthermore, in addition to this, the present invention may be applied to voice operation on an object in an AR space or a virtual reality (VR) space, communication with another user, or the like.

### 3-2. Other Modifications

Among the processes described in the above embodiments, all or a part of the processes described as being performed automatically can be performed manually, or all or a part of the processes described as being performed manually can be performed automatically by a known method. In addition, the processing procedure, specific name, and information including various data and parameters illustrated in the document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like. For example, voice recognition unit 13a and meaning understanding unit 13b illustrated in FIG. 5 may be integrated. In addition, the acquisition unit 13d and the call determination unit 13e similarly illustrated in FIG. 5 may be integrated.

Furthermore, each function executed by the control unit 13 of the terminal device 10 illustrated in FIG. 5 may be executed by the server device 100. In such a case, the terminal device 10 used by the user includes the voice input unit 2, the display unit 3, the voice output unit 4, and the communication unit 11, transmits and receives information to and from the server device 100 via the network N, and functions as a so-called voice UI device that presents the execution result of each function in the server device 100 to the user through interaction with the user.

In addition, the above-described embodiments can be appropriately combined in an area in which the processing contents do not contradict each other. In addition, the order of each Step illustrated in the sequence diagram or the flowchart of the present embodiment can be changed as appropriate.

### 4. Hardware Configuration

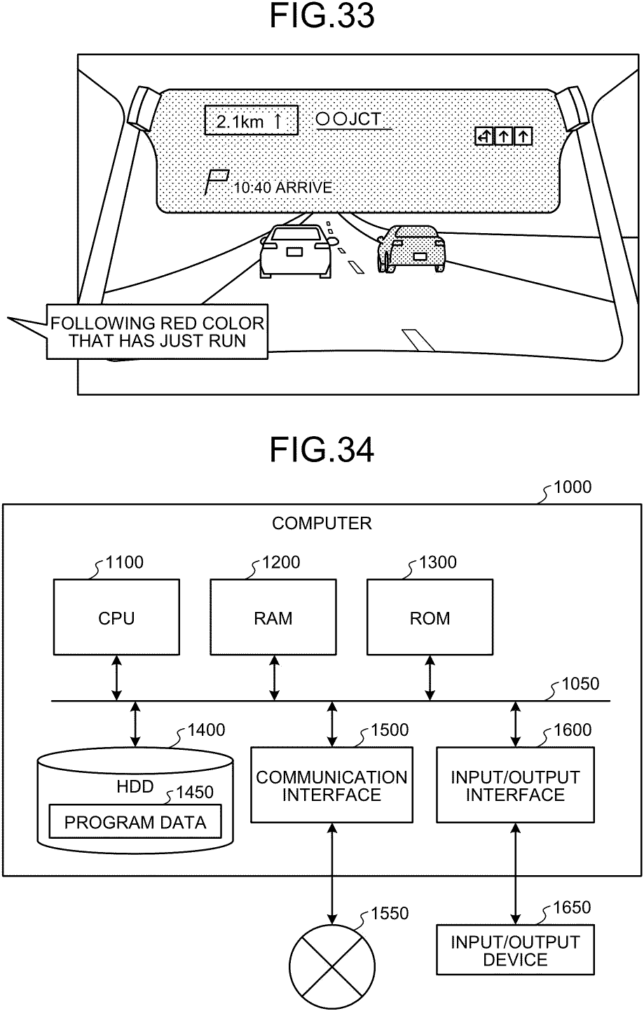

The information device such as the terminal device 10 and the server device 100 according to the above-described embodiment is realized by a computer 1000 having a configuration as illustrated in FIG. 34, for example. Hereinafter, the terminal device 10 according to the embodiment will be described as an example. FIG. 34 is a hardware configuration diagram illustrating an example of the computer 1000 that implements the functions of the terminal device 10. The computer 1000 includes a CPU 1100, a RAM 1200, a ROM 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of a program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting a input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the terminal device 10 according to the embodiment, the CPU 1100 of the computer 1000 executes the information processing program loaded on the RAM 1200 to implement the functions of the voice recognition unit 13a, the meaning understanding unit 13b, the interactive game execution unit 13c, the acquisition unit 13d, the call determination unit 13e, the transmission/reception unit 13f, and the like. In addition, the HDD 1400 stores the information processing program according to the present disclosure and data in the storage unit 12. Note that the CPU 1100 reads the program data 1450 from the HDD 1400 and executes the program data, but as another example, these programs may be acquired from another device via the external network 1550.

### 5. Conclusion

As described above, according to an embodiment of the present disclosure, the terminal device 10 (corresponding to an example of an “information processing apparatus”) includes the acquisition unit 13d that acquires the feature value regarding the object (corresponding to an example of the“ display element”) that can be the target of the voice command uttered by the user, and a call determination unit 13e (corresponding to an example of the “determination unit”) that determines the call of the object such that the object is uniquely specified with another object other than the object on the basis of the feature value acquired by the acquisition unit 13d. As a result, it is possible to assign a uniquely identifiable call to an object for which general-purpose voice recognition is difficult.

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.

(1) An information processing apparatus comprising:
an acquisition unit that acquires a feature value related to a display element that is a target of a voice command uttered by a user; and
a determination unit that determines a call of the display element on the basis of the feature value acquired by the acquisition unit such that the display element is uniquely specified with another display element other than the display element.

(2) The information processing apparatus according to (1), wherein the acquisition unit acquires a state value of the display element acquired from an analysis result of an image including the display element and/or an attribute value set in the display element as the feature value.

(3) The information processing apparatus according to (1) or (2),

wherein the determination unit compares a first feature value that is the feature value of the display element with a second feature value that is the feature value of another display element corresponding to the first feature value, and determines the call of the display element so that the first feature value is included when the first feature value has uniqueness from the second feature value.

(4) The information processing apparatus according to (3), wherein the determination unit sequentially searches the first feature values and compares the first feature value with the second feature value when the display element has a plurality of the first feature values, and determines the call of the display element such that the first feature value is included when the first feature value has uniqueness from the second feature value.

(5) The information processing apparatus according to any one of (1) to (4), wherein the determination unit determines whether or not the call of the display element has uniqueness by assigning a time-series reserved word to the call of the display element when a change in the feature value of the display element or occurrence of an event related to the display element is detected, and determines the time-series reserved word as the call of the display element when the call has uniqueness.

(6) The information processing apparatus according to (5), wherein the determination unit assigns a pronoun to the call of the display element when the display element is an element relating to a message transmitted and received among a plurality of the users.

(7) The information processing apparatus according to (6), wherein when the display element is an element related to a partner user of the message, the determination unit assigns a personal pronoun according to genders or the number of the partner users to the call of the display element.

(8) The information processing apparatus according to any one of (1) to (7),
wherein the acquisition unit acquires the feature value related to a position of the display element, and
the determination unit determines whether or not the call of the display element has uniqueness by including a positional reserved word corresponding to the position of the display element with respect to the call of the display element, and determines the call of the display element by including the positional reserved word when the call has uniqueness.

(9) The information processing apparatus according to (8),
wherein the position of the display element includes a two-dimensional position, and
when the call of the display element has uniqueness by including the positional reserved word indicating upper, lower, left, or right according to the two-dimensional position with respect to the call of the display element, the determination unit determines the call of the display element by including the positional reserved word.

(10) The information processing apparatus according to (8) or (9),
wherein the position of the display element includes a three-dimensional position, and
when the call of the display element has uniqueness by including the positional reserved word indicating front or back according to the three-dimensional position with respect to the call of the display element, the determination unit determines the call of the display element by including the positional reserved word.

(11) The information processing apparatus according to any one of (1) to (10),
wherein the acquisition unit acquires the feature value with respect to a distance of the display element from a predetermined reference point, and
the determination unit determines whether the call of the display element has uniqueness by including a distance reserved word or a time-series reserved word according to a distance of the display element with respect to the call of the display element, and determines the call of the display element by including the distance reserved word or the time-series reserved word when the call has uniqueness.

(12) The information processing apparatus according to (11),

wherein the acquisition unit sets the distance from the predetermined reference point of the display element as a spatial distance or a temporal distance.

(13) The information processing apparatus according to any one of (1) to (12),
wherein the acquisition unit acquires the feature value of the display element that is displayed in common among a plurality of the users, and
the determination unit determines the call of the display element by integrating the calls so that the calls of the display elements are aligned among the plurality of users on the basis of the feature value acquired by the acquisition unit.

(14) The information processing apparatus according to any one of (1) to (13),

wherein the determination unit determines priority and a target range for determining a call of the display element based on an importance level of each of a plurality of the display elements calculated from a predetermined reference point, and determines the call the display element in order according to the priority for the target range.

(15) The information processing apparatus according to (14),

wherein when change of the reference point is instructed from the user, the determination unit recalculates the importance level according to the change and changes the priority and the target range according to the recalculated importance level.

(16) The information processing apparatus according to (15),

wherein when a spatial change of the reference point is instructed from the user, the determination unit recalculates the importance level according to the spatial change.

(17) The information processing apparatus according to (15) or (16),

wherein when a change in which the reference point is temporally past is instructed from the user, the determination unit acquires the importance level in a past image according to the change in which the reference point is temporally past.

(18) The information processing apparatus according to any one of (15) to (17),

wherein the determination unit resets the target range when the calls of all the display elements in the target range are not uniquely determined.

(19) The information processing apparatus according to any one of (1) to (18),

wherein the display element is an object to be presented to the user.

(20) An information processing method comprising:
acquiring a feature value related to a display element that is a target of a voice command uttered by a user; and
determining a call of the display element on the basis of the feature value acquired by the acquiring such that the display element is uniquely specified with another display element other than the display element.

(21) A computer-readable recording medium storing a program for realizing, by a computer,
acquiring a feature value related to a display element that is a target of a voice command uttered by a user and
determining a call of the display element on the basis of the feature value acquired by the acquiring such that the display element is uniquely specified with another display element other than the display element.

REFERENCE SIGNS LIST

| | |
|---|---|
| 1 | INFORMATION PROCESSING SYSTEM |
| 2 | VOICE INPUT UNIT |
| 3 | DISPLAY UNIT |
| 4 | VOICE OUTPUT UNIT |
| 10 | TERMINAL DEVICE |
| 11 | COMMUNICATION UNIT |
| 12 | STORAGE UNIT |
| 12 a | RECOGNITION MODEL |
| 12 b | OBJECT INFORMATION DB |
| 12 c | RESERVED WORD INFORMATION DB |
| 13 | CONTROL UNIT |
| 13 a | VOICE RECOGNITOIN UNIT |
| 13 b | MEANING UNDERSTANDING UNIT |
| 13 c | INTERACTIVE GAME EXECUTION UNIT |
| 13 d | ACQUISTION UNIT |
| 13 e | CALL DETERMINATION UNIT |
| 13 f | TRANSMISSION/RECEPTION UNIT |
| 100 | SERVER DEVICE |
| 101 | COMMUNICATION UNIT |
| 102 | STORAGE UNIT |
| 102 a | OBJECTION INFORMATION DB |
| 102 b | RSERVED WORD INFORMATION DB |
| 103 | CONTROL UNIT |
| 103 a | COLLECTION UNIT |
| 103 b | GAME PROGRESS CONTROL UNIT |
| 103 c | ACQUISTION UNIT |
| 103 d | COMMON CALL DETERMINATION UNIT |
| 103 e | TRANSMISSION UNIT |

1. An information processing apparatus comprising:
an acquisition unit that acquires a feature value related to a display element that is a target of a voice command uttered by a user; and
a determination unit that determines a call of the display element on the basis of the feature value acquired by the acquisition unit such that the display element is uniquely specified with another display element other than the display element.

2. The information processing apparatus according to claim 1,
wherein the acquisition unit acquires a state value of the display element acquired from an analysis result of an image including the display element and/or an attribute value set in the display element as the feature value.

3. The information processing apparatus according to claim 1,
wherein the determination unit compares a first feature value that is the feature value of the display element with a second feature value that is the feature value of another display element corresponding to the first feature value, and determines the call of the display element so that the first feature value is included when the first feature value has uniqueness from the second feature value.

4. The information processing apparatus according to claim 3,
wherein the determination unit sequentially searches the first feature values and compares the first feature value with the second feature value when the display element has a plurality of the first feature values, and determines the call of the display element such that the first feature value is included when the first feature value has uniqueness from the second feature value.

5. The information processing apparatus according to claim 1,
wherein the determination unit determines whether or not the call of the display element has uniqueness by assigning a time-series reserved word to the call of the display element when a change in the feature value of the display element or occurrence of an event related to the display element is detected, and determines the time-series reserved word as the call of the display element when the call has uniqueness.

6. The information processing apparatus according to claim 5,
wherein the determination unit assigns a pronoun to the call of the display element when the display element is an element relating to a message transmitted and received among a plurality of the users.

7. The information processing apparatus according to claim 6,
wherein when the display element is an element related to a partner user of the message, the determination unit assigns a personal pronoun according to genders or the number of the partner users to the call of the display element.

8. The information processing apparatus according to claim 1,
wherein the acquisition unit acquires the feature value related to a position of the display element, and
the determination unit determines whether or not the call of the display element has uniqueness by including a positional reserved word corresponding to the position of the display element with respect to the call of the display element, and determines the call of the display element by including the positional reserved word when the call has uniqueness.

9. The information processing apparatus according to claim 8,
wherein the position of the display element includes a two-dimensional position, and
when the call of the display element has uniqueness by including the positional reserved word indicating upper, lower, left, or right according to the two-dimensional position with respect to the call of the display element, the determination unit determines the call of the display element by including the positional reserved word.

10. The information processing apparatus according to claim 8,
wherein the position of the display element includes a three-dimensional position, and
when the call of the display element has uniqueness by including the positional reserved word indicating front or back according to the three-dimensional position with respect to the call of the display element, the determination unit determines the call of the display element by including the positional reserved word.

11. The information processing apparatus according to claim 1,
wherein the acquisition unit acquires the feature value with respect to a distance of the display element from a predetermined reference point, and
the determination unit determines whether the call of the display element has uniqueness by including a distance reserved word or a time-series reserved word according to a distance of the display element with respect to the call of the display element, and determines the call of the display element by including the distance reserved word or the time-series reserved word when the call has uniqueness.

12. The information processing apparatus according to claim 11,
wherein the acquisition unit sets the distance from the predetermined reference point of the display element as a spatial distance or a temporal distance.

13. The information processing apparatus according to claim 1,
wherein the acquisition unit acquires the feature value of the display element that is displayed in common among a plurality of the users, and
the determination unit determines the call of the display element by integrating the calls so that the calls of the display elements are aligned among the plurality of users on the basis of the feature value acquired by the acquisition unit.

14. The information processing apparatus according to claim 1,
wherein the determination unit determines priority and a target range for determining a call of the display element based on an importance level of each of a plurality of the display elements calculated from a predetermined reference point, and determines the call the display element in order according to the priority for the target range.

15. The information processing apparatus according to claim 14,
wherein when change of the reference point is instructed from the user, the determination unit recalculates the importance level according to the change and changes the priority and the target range according to the recalculated importance level.

16. The information processing apparatus according to claim 15,
wherein when a spatial change of the reference point is instructed from the user, the determination unit recalculates the importance level according to the spatial change.

17. The information processing apparatus according to claim 15,
wherein when a change in which the reference point is temporally past is instructed from the user, the determination unit acquires the importance level in a past image according to the change in which the reference point is temporally past.

18. The information processing apparatus according to claim 15,
wherein the determination unit resets the target range when the calls of all the display elements in the target range are not uniquely determined.

19. The information processing apparatus according to claim 1,
wherein the display element is an object to be presented to the user.

20. An information processing method comprising:
acquiring a feature value related to a display element that is a target of a voice command uttered by a user; and
determining a call of the display element on the basis of the feature value acquired by the acquiring such that the display element is uniquely specified with another display element other than the display element.
